(19) United States
(12) Patent Application Publication
(10) Pub. No.: US 2009/0084766 A1
(43) Pub. Date: Apr. 2, 2009

(54) LASER CUTTING SYSTEM AND METHOD

(76) Inventors: Michael Moritz, Bruchsal (DE); Thomas Metzger, Ketsch (DE)

Correspondence Address: DEERE & COMPANY, ONE JOHN DEERE PLACE, MOLINE, IL, 61265, US

(21) Appl. No.: 12/169,760

(22) Filed: Jul. 9, 2008

(30) Foreign Application Priority Data
Sep. 27, 2007 (DE) 10 2007 046142.0

(51) Int. Cl. B23K 26/00

(52) U.S. Cl. 219/121.72

(57) ABSTRACT

A laser cutting system and method are provided. The system (10) includes an electronically controllable robot (12) for bringing a laser cutting head (22) to prescribable reference positions with respect to a workpiece (24), a programmable control device (18), provided with a memory, for controlling the robot (12) with respect to reference position coordinates stored in the memory, and a distance correcting device (26) for correcting the distance of the laser cutting head (22) from the workpiece after the laser cutting head (22) has been brought to the reference position defined by the reference position coordinates. To ensure a prescribed quality standard during the laser cutting, certain tolerances on the workpiece (24) must be maintained. In order to avoid additional measuring steps for measuring the workpiece (24), the control unit (18) is formed and programmed so that a comparison of the position coordinates acquired by the control unit (18) after distance correction of the laser cutting head (22) with the reference position coordinates stored in the memory takes place before a laser cutting process is initiated.

### FIELD OF THE INVENTION

The present invention relates to a system and a method for the laser cutting of a workpiece.

### BACKGROUND OF THE INVENTION

It is known to use laser cutting systems to process workpieces, in particular for forming indentations or recesses into the workpiece.

Such a system and an associated method are disclosed, for example, in DE 37 00 829 A1. The latter relates in particular to a system and a method for laser beam work such as cutting, welding and the like, in order for metal cutting operations to be carried out on an assembly line by means of a laser beam. The system has a relatively elaborate process of using sensors to control the position of the laser beam head or the cutting nozzle.

DE 34 45 981 A1 discloses a system and a method for processing workpieces with a laser beam emerging from a laser head, the system having a height sensing device, which is used for regulating or monitoring an in-focus distance of the laser head from the workpiece. In this case, the height sensing device is directly connected to a numerical control system, the distance between the workpiece and the laser head being corrected according to a height correction signal supplied to the numerical control system by the height sensing device. It is found to be disadvantageous that the correction takes place both on the workpiece side and on the laser head side, and consequently a relatively complex control system is used to ensure a certain quality standard in the processing of the workpiece.

A further system and an associated method for the laser processing of workpieces are disclosed in U.S. Pat. No. 6,545,250. In the case of the latter, a scanning mirror reflection device is coupled to an optical detector and a correction signal is generated, on the basis of which a corrective deflection of the laser beam takes place, without a relative movement between the laser beam head and the workpiece having to be performed. This correction device has been found to be very elaborate and complex.

Furthermore, DE 10 2004 043 076 A1 discloses a method for monitoring a laser-beam processing operation, a laser head that is fastened to a robot arm being positioned in relation to a workpiece that is to be processed. During the processing, the surface of the workpiece is sensed by a deflecting device and a focusing device for a laser beam in a processing zone, the surface of the workpiece and the point of impingement of the laser beam being monitored by means of a camera and corresponding actual-value signals obtained. When there is a corresponding deviation from prescribed set values, corrective actuating signals are generated and fed to corresponding actuating elements of the robot arm and/or the deflecting device and/or the focusing device. It is found to be disadvantageous that here too the sensor technology used for generating corrective signals is relatively elaborate and complex.

### SUMMARY OF THE INVENTION

Accordingly, an object of this invention is to provide a system and a method by which certain tolerances on the workpiece are maintained to ensure a prescribed quality standard during the laser cutting, without additional, elaborate and complex sensor and/or correction systems being used.

This and other objects are achieved by the present invention, wherein such a system is provided with an electronic control unit, which is formed and programmed in such a way that a comparison of the position coordinates acquired by the control unit after distance correction of the laser cutting head with the reference position coordinates stored in the memory takes place before a laser cutting process is initiated. The advantage of this is that it is possible to dispense with additional sensor and correction devices and the control unit that is present in any case for the first robot is used to acquire the position coordinates after distance correction, in that the position data are acquired or read out and compared with the reference data.

In a preferred embodiment, the control unit is formed and programmed in such a way that an abort control signal, which aborts the cutting process, is generated after the comparison if the difference between at least one stored reference position coordinate and the correspondingly acquired position coordinate exceeds a prescribable tolerance value. The fact that an abort signal is generated means on the one hand that there is no need for time-consuming processing to be carried out by laser cutting a workpiece that is outside the tolerance of reference values and would not pass subsequent quality control and on the other hand that there is an increase in product quality to the extent that only workpieces with passable tolerance undergo processing by laser cutting.

In a further preferred embodiment, a second robot is provided for the positioning of the workpiece, by which robot the workpiece is gripped and transported into at least one processing position for laser cutting, the second robot being formed in such a way that, when the laser cutting process is completed or aborted, the workpiece is transported from the processing position into a further position. This ensures that, when the tolerance between at least one stored reference position coordinate and the correspondingly acquired position coordinate is not maintained, the defective workpiece can be transported out of a laser-cutting processing position by the second robot, with the result that a new workpiece can be processed in the laser cutting process without any significant interruption. In this case, the defective workpiece (reject part), which exceeds the tolerance threshold, can be transported to a place for reject parts, which can then be sent on for re-processing or disposal. Once the defective workpiece has been transported to this place, the positioning of a new workpiece by the second robot takes place straight away.

A corresponding method according to the invention for the laser cutting of a workpiece comprises the method steps that a laser cutting head is brought to a prescribable reference position with respect to a workpiece by a first robot, which can be controlled by means of an electronic control unit, and, after the laser cutting head has been brought to the prescribed reference position, a correction of the distance of the laser cutting head from the workpiece is carried out by means of a distance correcting device, preferably controlled by the control unit, the control unit acquiring the position coordinates after the distance correction of the laser cutting head and comparing them with the prescribed reference position coordinates. Therefore, the robotic control device of a laser cutting system is used directly to establish specifically whether a reject part is concerned, without using additional measuring methods prior to the processing by laser cutting, with the result that it is possible to prevent superfluous laser cutting operations from being performed on a defective workpiece and at the same time it is possible to increase effectively the quality of the overall processing process or the overall end product by sensing and selecting the reject parts, without having to take additional measures in the form of providing elaborate, additional measuring systems.

In a preferred refinement of the invention, an abort control signal, which aborts the cutting process if the difference between at least one stored reference position coordinate and the correspondingly acquired position coordinate exceeds a prescribable tolerance value, is generated after the comparison. As previously mentioned, this achieves the effect that the laser cutting method can be specifically aborted as soon as it is established that a reject part is concerned.

In a further embodiment, the workpiece for the laser cutting process can be gripped by a second robot and transported into at least one processing position for laser cutting and, when the laser cutting process is completed or aborted, transported from the processing position into a further position.

After completion of the laser cutting, the workpiece is preferably transported into a position other than the position associated with an abnormal termination of the laser cutting. The position associated with an abnormal termination is, for example, a reject position, into which the workpiece is brought if it does not satisfy the tolerance requirements. Corresponding processes for correction or disposal of the workpiece can then take place from this position.

### BRIEF DESCRIPTION OF THE DRAWINGS

FIG. 1 is a schematic view of a system for laser cutting according to the invention; and

FIG. 2 is a logic flow diagram of a method for laser cutting according to the invention.

### DESCRIPTION OF THE PREFERRED EMBODIMENT

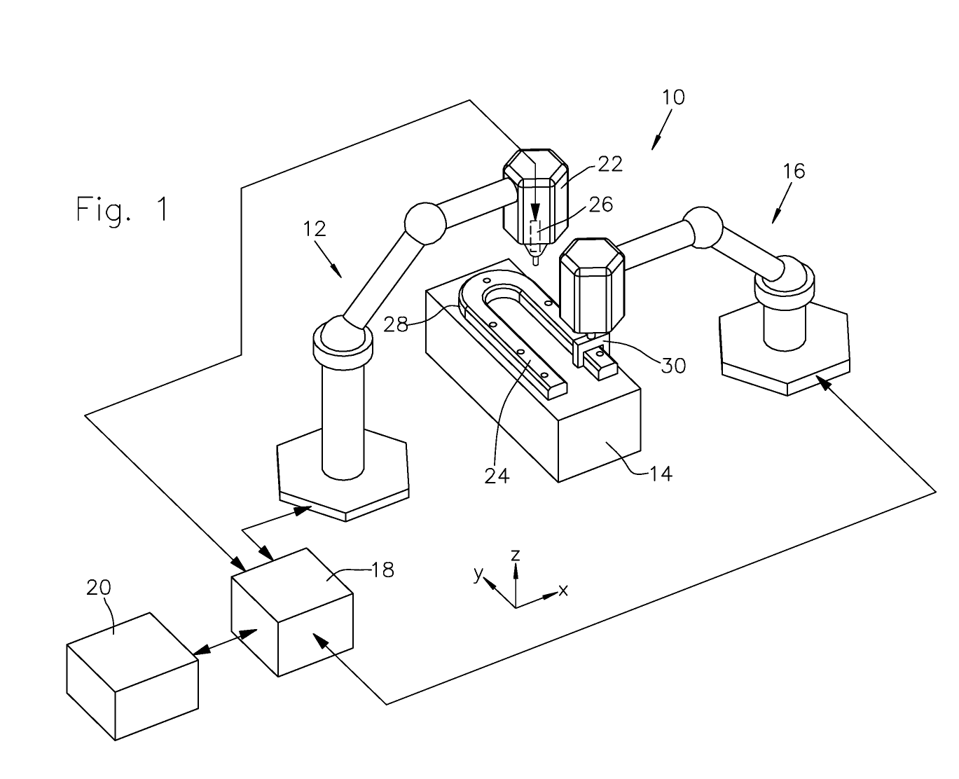

FIG. 1 shows an electronically controlled laser beam cutting system 10. The system 10 includes a first electronically controlled robot or manipulator 12, a tool table 14, a second electronically controlled robot or manipulator 16, an electronic, preferably programmable, control unit 18, and also a data input and data output system or data read-in and data read-out system 20.

The first robot 12 is provided with a laser cutting head 22 and is formed in such a way that it can move or position the latter spatially, that is to say in at least three degrees of freedom (x, y, z). The robot 12 is preferably formed in such a way that, with respect to a workpiece 24 positioned on the tool table 14, it can move or position the laser cutting head 22 along the surface of the workpiece 24 with respect to fixed reference points on the workpiece. The robot 12 is activated by means of the electronic control unit 18, the electronic control unit 18 sending control signals to a robot control system (not shown), which in turn moves the robot 12, or the laser cutting head 22 fastened to the robot 12, in accordance with the emitted control signals.

The laser cutting head 22 is connected to a laser device (not shown), which is suitable for the laser processing of vehicle body components or frame components, in particular made of metal. The laser cutting head 22 has an automatic distance correcting device 26, which is used to carry out a fine adjustment of the laser cutting head 22 after a change in position or a corrective positioning of the laser cutting head 22. As a result, the laser cutting head 22 can be brought to a final distance from the workpiece 24 that is suitable for the laser cutting process, with the result that corresponding focusing of the laser on the surface that is to be processed takes place automatically. This distance correction is necessary since every workpiece 24 has certain structural or dimensional tolerances, which may exceed a distance tolerance allowed for the laser cutting head 22, with the result that a fine adjustment of the laser cutting 22 or a focusing of the laser beam takes place for each processing point on the workpiece 24. This distance correction preferably takes place capacitively by automated capacitive distance measuring methods that are known in the prior art. It may, however, also take place by means of optical or magneto-inductive methods.

The tool table 14 is provided with a work holder 28, into which the workpiece 24 is fitted by means of the second robot 16. When there is a change from one workpiece 24 to another workpiece 24 of identical construction, it is ensured by the work holder 28 that the workpieces 24 that are to be processed are brought into an exactly identical processing position. The exact processing position for the workpiece 24 is prescribed to the control unit 18 by the data read-in system with respect to a spatially fixed system of coordinates (x, y, z). Accordingly, the second robot 16 is also activated by means of the electronic control unit 18, the electronic control unit 18 sending control signals to a robot control system (not shown), which in turn moves the robot 16, or the workpiece 24 positioned by the robot 16, in accordance with the emitted control signals. For this purpose, the robot 16 is for example provided with a gripping device 30, which is likewise controlled by the control unit 18 and by which the workpiece 24 can be gripped and positioned.

The robot control systems (not shown) that can be activated by the electronic control unit are formed for example as pneumatic, hydraulic or electric actuating motors, at least one of these actuating motors for each degree of freedom (x, y, z) being provided on each robot 12, 16.

As already mentioned, the electronic control unit 18 is connected to the first robot 12 and the second robot 16. Furthermore, it is connected to the distance correcting device 26 of the laser cutting head 22 and receives from the latter corresponding position correction signals once positioning of the laser cutting head 22 to a processing point on the workpiece 24 has taken place. The electronic control unit 18 is formed in such a way that on one hand it activates the robots 12, 16 or sets them in motion according to the generated control signals in conjunction with the corresponding robot control systems and on the other hand it receives signals generated by the robot control systems and exactly reproducing the position of the laser cutting head 22. It is therefore possible that, by using positioning coordinates can be prescribed by means of the data input system 20, the control unit 18 can both perform positioning of the robot or robots 12, 16 and read out or enquire positioning coordinates. The electronic control unit 18 preferably has a programmable memory, in which for example reference data with respect to position coordinates for the laser cutting head 22 of the first robot 12 or position coordinates for the gripper 30 of the second robot are stored. Furthermore, the control unit 18 is provided with a processor (not shown), which can execute programmable computation algorithms.

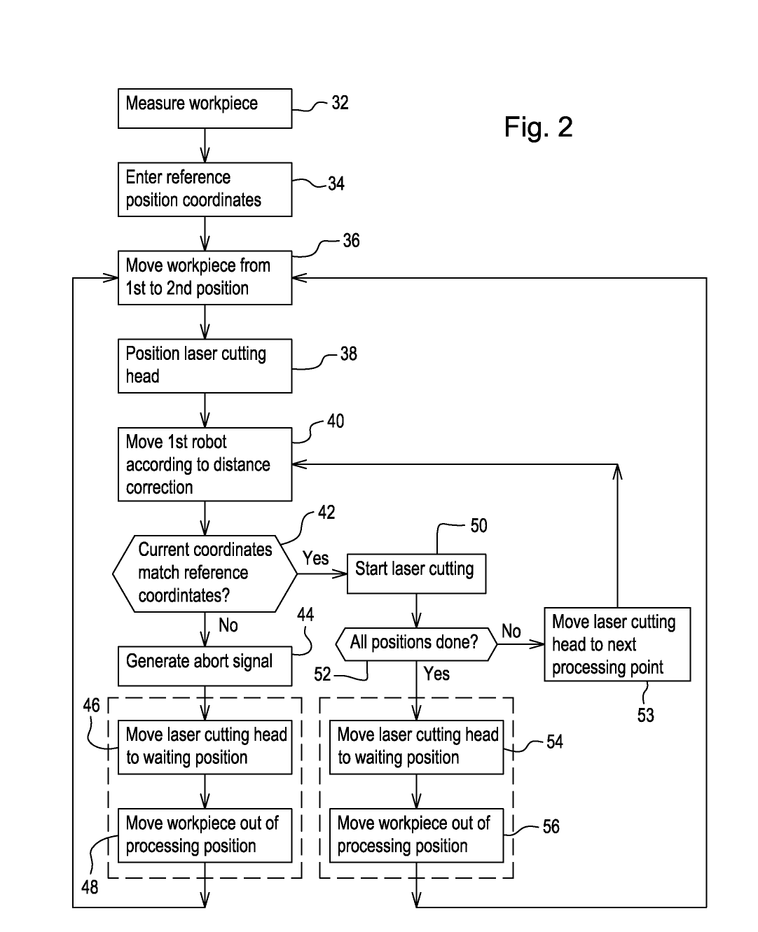

The method associated with the system 10 is represented in FIG. 2, and includes the following steps:

32: To determine reference data, firstly a workpiece 24, which has been brought into a prescribable form in a shaping process, for example by bending, is measured by a measuring device (not shown), in order to ensure that this workpiece 24 corresponds to the required tolerance requirements. This workpiece serves as a reference workpiece, on which corresponding reference position coordinates with respect to a spatially fixed system of coordinates (x, y, z) are fixed. The tool table 14 is in this case fixed with respect to the system of coordinates (x, y, z). The laser cutting process, following the shaping process, provides for processing to be performed at prescribed processing points on the workpiece 24. In accordance with these prescribed processing points, the reference position coordinates for the positioning of the laser cutting head 22 are fixed. Furthermore, reference position coordinates for the positioning of the workpieces 24 that are to be processed, or for the gripping device 30 gripping the workpiece, are fixed.

34: The reference position coordinates are fed to the electronic control unit 18.

36: The electronic control unit 18 controls the second robot 16 in accordance with the reference position coordinates in such a way that said robot uses the gripping device 30 to grip a workpiece 24 that is to be processed and transport it from a first position (for example a storage position) into a second position, namely into the processing position fixed by the reference position coordinates, on the tool table 14.

38: The electronic control unit 18 controls the first robot 12 in accordance with the reference position coordinates for the processing points in such a way that the laser cutting head 22 is positioned at the first processing point on the workpiece 24.

40: The electronic control unit 18 carries out the required distance correction by activating the first robot 12 on the basis of the distance values supplied by the distance correcting device 26.

42: After distance correction, the electronic control unit 18 acquires the current position coordinates of the first robot 12 or of the laser cutting head 22 and compares them with the reference position coordinates, for example by forming differential values.

44: If a determined differential value exceeds a prescribed tolerance value or threshold value, which is for example stored in the memory of the electronic control unit 18 or defined in the control algorithm, an abort signal is generated by the electronic control unit 18.

46: After an abort signal, no laser cutting process is started and the first robot 12 is activated by the electronic control unit 18 and the laser cutting head is positioned in a preprogrammed waiting position.

48: At the same time or thereafter (therefore surrounded by dashed lines in FIG. 2), the second robot 16 is activated by the electronic control unit 18 in such a way that it transports the workpiece 24 from the processing position on the tool table 14 into another position, for example into a reject part position, in which the workpiece 24 can be correctively processed or sent on for disposal. Subsequently, the method for laser cutting is continued with method step 36.

50: If, however, the differential value determined in method step 42 lies within the tolerance, the laser cutting process is started at this processing point of the workpiece 24.

52: After laser cutting, the first robot 12 is activated by the electronic control unit 18 and the laser cutting head 22 is moved to the next processing point on the workpiece 24, or positioned there, in accordance with the described reference position coordinates. Subsequently, the method for laser cutting is continued with method step 40.

54: Once all the processing points provided on the workpiece 24 (in accordance with the reference position coordinates) have been processed by laser cutting, the first robot 12 is activated by the electronic control unit 18 and the laser head 22 is positioned in a preprogrammed waiting position.

56: At the same time or thereafter (therefore surrounded by dashed lines in FIG. 2), the second robot 16 is activated by the electronic control unit 18 in such a way that it transports the workpiece 24 from the processing position on the tool table 14 into another position, for example into a further processing position in which the workpiece 24 is positioned for further processing. Subsequently, the method for laser cutting is continued with method step 36.

The conversion of the above flow chart into a standard language for implementing the algorithm described by the flow chart in a digital computer or microprocessor, will be evident to one with ordinary skill in the art.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A laser cutting system for forming a workpiece (24), the system having an electronically controllable first robot (12) for bringing a laser cutting head (22) to prescribable reference positions with respect to a workpiece (24), a programmable control device (18), having a memory, for controlling the first robot (12) with respect to reference position coordinates stored in the memory, and a distance correcting device (26) for correcting the distance of the laser cutting head (22) from the workpiece (24) after the laser cutting head (22) has been brought to the reference position defined by the reference position coordinates, characterized in that:
the control unit (18) is formed and programmed so that the control unit (18) acquires position coordinates of the laser cutting head (22) and a comparison of the position coordinates acquired by the control unit (18) after distance correction of the laser cutting head (22) with the reference position coordinates stored in the memory takes place before a laser cutting process is initiated.

2. The laser cutting system of claim 1, wherein:
the control unit (18) is formed and programmed so that an abort control signal, which aborts the cutting process, is generated after the comparison if the difference between at least one stored reference position coordinate and the correspondingly acquired position coordinate exceeds a prescribable tolerance value.

3. The laser cutting system of claim 2, wherein:
a second robot (16) is provided for the positioning of a workpiece (24), by which robot (16) the workpiece (24) is gripped and transported into at least one processing position for laser cutting, the second robot (16) being formed so that, when the laser cutting process is completed or aborted, the workpiece (24) is transported from the processing position into a further position.

4. A method for laser cutting a workpiece (24) with a laser cutting system having a laser cutting head (22) movable by a robot which is controlled by an electronic control unit and having a distance correcting device, the method comprising:
moving the laser cutting head (22) to a prescribable reference position with respect to the workpiece (24) by the robot (12),
then, correcting a distance of the laser cutting head (22) from the workpiece by the distance correcting device (26);
then, acquiring, by the control unit (18), position coordinates of the laser cutting head (22) and comparing them with coordinates of the prescribed reference position.

5. The method of claim 4, further comprising:
generating an abort control signal, which aborts the cutting process if the difference between at least one stored reference position coordinate and the correspondingly acquired position coordinate exceeds a prescribable tolerance value.

6. The method of claim 5, further comprising:
gripping the workpiece (24) by a second robot (16) for positioning the workpiece (24);
transporting the workpiece into at least one processing position for laser cutting; and
when the laser cutting process is completed or aborted, transporting the workpiece (24) from the processing position into a further position.

7. The method of claim 6, wherein:
the further position when laser cutting is completed differs from the further position when laser cutting is aborted.
